(19) United States
(12) Patent Application Publication
(10) Pub. No.: US 2026/0121696 A1
(43) Pub. Date: Apr. 30, 2026

(54) MULTI-FUNCTIONAL SHARED APERTURE 8N-PORT MIMO ANTENNA SYSTEM

(71) Applicant: INDIAN INSTITUTE OF TECHNOLOGY DELHI, New Delhi (IN)

(72) Inventors: Amar D. CHAUDHARI, Mumbai (IN); Soumava MUKHERJEE, Jodhpur (IN); Brejesh LALL, New Delhi (IN)

(73) Assignee: INDIAN INSTITUTE OF TECHNOLOGY DELHI, New Delhi (IN)

(21) Appl. No.: 19/057,259

(22) Filed: Feb. 19, 2025

(30) Foreign Application Priority Data
Oct. 28, 2024 (IN) 202411082319

(51) Int. Cl. H04B 7/0413; H01Q 3/30; H01Q 21/06

(52) U.S. Cl. CPC H04B 7/0413; H01Q 3/30; H01Q 21/065

(57) ABSTRACT

Embodiments herein disclose an antenna system comprising a plurality of panel comprising at least one Multiple Input Multiple Output (MIMO) antenna array, including a plurality of microstrip patch antenna elements and stacked patch antenna elements. The microstrip patch antenna elements, configured in a linear array, facilitate a lower operating frequency, while the stacked patch antenna elements, placed atop the microstrip patch antenna elements, achieve a higher operating frequency. The stacked patch antenna elements are connected in series and oriented at a predefined angle of 90° relative to the microstrip patch antenna elements. A panel from the plurality of panels is arranged at a pre-defined angle of 90° relative to an adjacent panel from the plurality of panels for polarization diversity to obtain the multifunctional shared aperture 8N-port MIMO antenna system.

### TECHNICAL FIELD

Embodiments disclosed herein relate to antenna systems for fifth generation (5G) millimeter-wave systems, and more particularly to a multi-functional shared aperture 8N-port MIMO antenna system.

### BACKGROUND

The advancement of 5th Generation (5G) technology is greatly expanding the potential of wireless communication. Employing Frequency Range 2 (FR2) millimeter-wave (mmWave) frequencies is crucial for achieving the low latency, high data rates, and enhanced network capacity required for future applications. The 3rd Generation Partnership Project (3GPP) has specified mmWave frequencies for 5G between 24 GHz and 52.6 GHZ, covering important bands such as n257, n258, n260, and n261. As outlined in Release 16, these frequencies can enable extraordinary data speeds, potentially reaching up to 20 Gigabits per second (Gbps) in the downlink. However, despite the potential of these frequencies, the deployment of antennas in the 5G mmWave band presents several technical challenges. The most notable issues include significant propagation losses, shorter transmission range, limited signal penetration, and multipath fading, all of which hinder the system's performance and necessitate the development of more advanced mmWave antenna technologies beyond conventional designs.

One of the primary techniques used to address these limitations is beamforming and beam steering. Beam steering enables the antenna array to dynamically adjust the beam's direction by altering the relative phases of the input radio signals, which is crucial for maintaining high-quality service. According to 3GPP standards, the beam should be narrow and capable of wide-angle scanning to ensure extensive coverage. Beam steering techniques are commonly used to either suppress co-channel interference or enhance the coverage of mmWave base stations. Despite its effectiveness, beam steering introduces its own set of drawbacks. The process of beam scanning can lead to delays, increased system complexity, and higher energy consumption. Furthermore, it can make the system more susceptible to interruptions caused by environmental changes, complicating the reliability of communication links.

Massive multiple-input multiple-output (MIMO) technology further enhances the capabilities of 5G networks by utilizing large-scale antenna arrays with beamforming and multibeam functionalities. This allows for significant improvements in spectral efficiency, network capacity, and frequency reuse. The shorter wavelengths at mmWave frequencies enable the deployment of large-scale arrays comprising of small, closely packed antenna elements, supporting spatial multiplexing. This allows multiple independent data streams to be transmitted simultaneously through different sub-arrays over the same frequency bands, making it valuable in high-density areas like urban environments. However, while beam scanning is crucial for preserving superior communication links, it can introduce additional delays, increase the complexity of the system, and consume more energy, all of which can degrade system performance in dynamic environments.

In the mmWave frequency band, multipath propagation becomes more pronounced due to reflections and scattering, especially in urban areas. Dual-band MIMO antennas can help mitigate these effects by providing diversity in both transmission and reception, selecting the most suitable band for communication based on real-time conditions. This makes the design of mmWave antennas that support MIMO diversity schemes critical for robust performance. Although MIMO antenna systems offer significant advantages in terms of improving data rates, link reliability, and channel capacity without requiring additional spectrum or power, they too are subject to challenges. Polarization diversity schemes within MIMO systems utilize multiple polarizations, typically vertical and horizontal, to mitigate fading and multipath interference. However, at mmWave frequencies, these signals are particularly prone to fluctuations due to environmental factors such as reflections and scattering, which can still impact the stability and reliability of the communication links.

Therefore, while 5G mmWave technologies, including beamforming, beam steering, and MIMO, offer significant improvements in wireless communication capabilities, they have several drawbacks as presented above. The current systems face limitations related to propagation losses, increased system complexity, energy consumption, and vulnerability to environmental changes. These drawbacks highlight the requirement for improved and enhanced antenna designs and system architectures to overcome these persistent issues.

Hence, there is a need in the art for solutions which will overcome the above-mentioned drawback(s), among others.

### OBJECTS

The principal object of the embodiments herein is to disclose a multifunctional shared aperture 8N-port MIMO antenna system that incorporates multiple MIMO antenna arrays for achieving efficient multiple-input-multiple-output communications.

Another object of the embodiments herein is to disclose a MIMO antenna array comprising a plurality of microstrip patch antenna elements spaced apart in a linear array configuration to operate at a lower frequency range.

Another object of the embodiments herein is to disclose the use of stacked patch antenna elements placed on top of the microstrip patch elements to achieve a higher frequency operation, thereby allowing dual-band functionality within the same aperture.

Another object of the embodiments herein is to disclose the incorporation of a meandered series feedline that introduces a 180° phase shift between the microstrip and stacked patch elements, enhancing the overall performance of the antenna array.

Another object of the embodiments herein is to disclose a configuration in which the stacked patch antenna elements are oriented at a 90° angle relative to the microstrip patch elements, providing polarization diversity.

Another object of the embodiments herein is to disclose a panel arrangement where adjacent panels are oriented at a predefined angle of 90° relative to each other, further enhancing polarization diversity for improved multifunctional performance in MIMO systems.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 shows the configuration of an example antenna system of a multi-functional shared-aperture 32-port 16×16 dual-band dual-beam series-fed stacked microstrip patch MIMO antenna array, according to the embodiments disclosed herein;

FIG. 2 shows the detailed geometry of the shared-aperture 8-port 4×4 dual-band dual-beam series-fed stacked microstrip patch MIMO antenna array, according to the embodiments disclosed herein;

FIG. 3A shows the lower-band microstrip patch antenna only, FIG. 3B shows the higher-band microstrip patch antenna only, and FIG. 3C shows the simulated reflection coefficients and gain, according to the embodiments disclosed herein;

FIG. 4 shows the configuration of a single shared-aperture dual-band dual-beam stacked microstrip patch antenna element, according to the embodiments disclosed herein;

FIG. 5 shows the simulated reflection and coupling coefficients of a single shared-aperture dual-band dual-beam stacked microstrip patch antenna element, according to the embodiments disclosed herein;

FIG. 6 shows the simulated gain and efficiency of a single shared-aperture dual-band dual-beam stacked microstrip patch antenna element, according to the embodiments disclosed herein;

FIG. 7 shows the simulated radiation patterns when Port 1 is active for a single shared-aperture dual-band dual-beam stacked microstrip patch antenna element at 28 GHZ, according to the embodiments disclosed herein;

FIG. 8 shows the simulated radiation patterns when Port 2 is active for a single shared-aperture dual-band dual-beam stacked microstrip patch antenna element at 38 GHZ, according to the embodiments disclosed herein;

FIG. 9A shows the reflection coefficients and FIG. 9B shows the E-plane (yoz-plane) radiation pattern at 28 GHZ, according to the embodiments disclosed herein;

FIG. 10A shows the reflection coefficients and FIG. 10B shows the E-plane (xoz-plane) radiation pattern at 38 GHz, according to the embodiments disclosed herein;

FIG. 11A shows the reflection coefficients and FIG. 11B shows the coupling coefficients, according to the embodiments disclosed herein;

FIG. 12A shows the reflection coefficients and FIG. 12B shows the coupling coefficients, according to the embodiments disclosed herein;

FIG. 13A shows the results for the lower band, and FIG. 13B shows the results for the higher band, according to the embodiments disclosed herein;

FIG. 14A shows the radiation pattern when Port 1 is excited at 28 GHZ, and FIG. 14B shows the radiation pattern when Port 5 is excited at 38 GHz, according to the embodiments disclosed herein;

FIG. 15 shows the simulated scanning performance of the shared-aperture 8-port 4×4 dual-band dual-beam series-fed stacked microstrip patch antenna array for Ports 1 to 4 in the H-plane at 28 GHZ, according to the embodiments disclosed herein;

FIG. 16 shows the simulated scanning performance of the shared-aperture 8-port 4×4 dual-band dual-beam series-fed stacked microstrip patch antenna array for Ports 5 to 8 at 38 GHz, according to the embodiments disclosed herein;

FIG. 17 shows a perspective view of the shared-aperture 4×4 dual-band dual-beam series-fed stacked microstrip patch antenna array fed by the SICL-based power divider network, according to the embodiments disclosed herein.

FIG. 18A shows the top layer, FIG. 18B shows the middle layer, and FIG. 18C shows the bottom layer, according to the embodiments disclosed herein;

FIG. 19A shows the results for the lower band, and FIG. 19B shows the results for the higher band, according to the embodiments disclosed herein;

FIG. 20A shows the top view, and FIG. 20B shows the bottom view, according to the embodiments disclosed herein;

FIG. 21A shows the reflection coefficients, and FIG. 21B shows the coupling coefficients, according to the embodiments disclosed herein;

FIG. 22 shows the simulated and measured normalized radiation patterns of the shared-aperture 4×4 dual-band dual-beam series-fed stacked microstrip patch antenna array fed by the SICL power-divider network for Port 1 at 28 GHZ, according to the embodiments disclosed herein;

FIG. 23 shows the simulated and measured normalized radiation patterns of the shared-aperture 4×4 dual-band dual-beam series-fed stacked microstrip patch antenna array fed by the SICL power-divider network for Port 2 at 38 GHZ, according to the embodiments disclosed herein;

FIG. 24 shows the simulated and measured gain and simulated efficiency of the shared-aperture 4×4 dual-band dual-beam series-fed stacked microstrip patch antenna array fed by the SICL power-divider network, according to the embodiments disclosed herein;

FIG. 25 shows the simulated 3D radiation patterns of the multi-functional shared-aperture 32-port 16×16 dual-band dual-beam series-fed stacked microstrip patch MIMO antenna array at 28 GHz, according to the embodiments disclosed herein;

FIG. 26 shows the simulated 3D radiation patterns of the multi-functional shared-aperture 32-port 16×16 dual-band dual-beam series-fed stacked microstrip patch MIMO antenna array at 38 GHZ, according to the embodiments disclosed herein;

FIG. 27A shows the results for the lower band, and FIG. 27B shows the results for the higher band, according to the embodiments disclosed herein; and

FIG. 28A shows the simulated MIMO performance metrics in terms of ECC and DG for the lower band, and FIG. 28B shows the results for the higher band, according to the embodiments disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help casily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

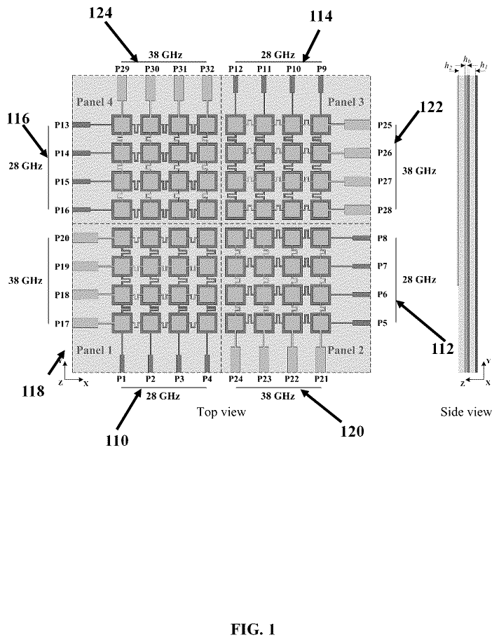

The embodiments herein provide a multi-functional MIMO antenna system comprising a shared-aperture dual-band, dual-beam, series-fed stacked microstrip patch design, configured for MIMO operation. The system supports dual-band functionality, allowing simultaneous operation across two distinct frequency bands, i.e., 28 GHz and 38 GHZ, while the dual-beam feature enables the transmission and reception of two independent beams. The series-fed architecture ensures phases of the feed signals among the stacked microstrip patches, and the antenna system configuration facilitates spatial multiplexing for enhanced data throughput in MIMO applications. The antenna system, according to the embodiments herein, enhances spectrum efficiency, capacity, coverage, and reliability and is optimized for high-performance applications in 5G and beyond wireless communication systems. Referring now to the drawings, and more particularly to FIGS. 1 through 28, where similar reference characters denote corresponding features consistently throughout the figures, there are shown embodiments.

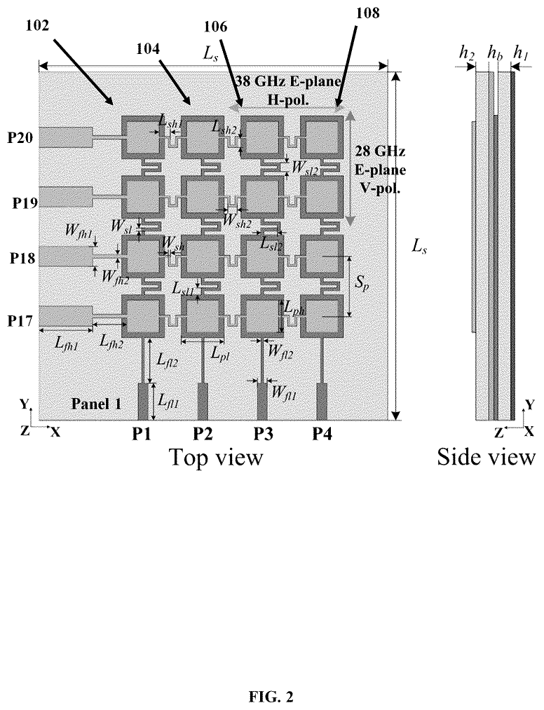

FIG. 1 illustrates a schematic of the multi-functional shared aperture 8N-port MIMO antenna system 100, according to the embodiments herein. The antenna system comprises a plurality of panels and each of the plurality of panels comprises at least one MIMO antenna array. The at least one MIMO antenna array comprises a plurality of microstrip patch antenna elements and a plurality of stacked patch antenna elements. The plurality of microstrip patch antenna elements for obtaining a lower operating frequency are spaced apart from each other in a linear array configuration. The plurality of stacked patch antenna elements for obtaining a higher operating frequency are placed on top of the plurality of microstrip patch antenna elements in a linear array configuration. A series feedline connects each of the plurality of stacked patch elements in series. The series feedline can be any appropriate feedline that introduces a 180° phase shift. In an example, the series feedline is meandered. The plurality of stacked patch antenna elements are oriented at a pre-defined angle of 90° relative to the plurality of microstrip antenna elements. According to the embodiments herein, each of the at least one antenna array comprises a 1×N linear array thereby forming an N×N port MIMO system for both the low and high bands (with a total of 2N ports), where N is the number of microstrip patch antenna elements in a single row of a linear array. FIG. 1 illustrates an antenna system comprising four 8-port 4×4 dual-band dual-beam series-fed stacked microstrip patch MIMO antenna arrays placed rotationally symmetrical with an interval of 90° to each other for polarization diversity. The four antenna arrays of Panel 1 are shown in FIG. 2 as a first antenna array 102, a second antenna array 104, a third antenna array 106, and a fourth antenna array 108. In each of the four antenna arrays, there are a plurality of microstrip/stacked patch antenna elements which are spaced equidistant from each other. The plurality of stacked patch antenna elements for obtaining a higher operating frequency are placed on top of the plurality of microstrip patch antenna elements in a linear array configuration. Each linear array therefore comprises 1×N array with a total of 2N ports, thereby forming an N×N array of the plurality of microstrip/stacked patch antenna elements in each of the panel, where N is the number of microstrip/stacked patch antenna elements in a row of the linear array in each panel. In FIG. 1, 1×4 linear array configuration of the plurality of microstrip/stacked patch antenna elements is shown in each of the panels. For example, in Panel 1, as shown in FIG. 2, in the first antenna array 102, the number of microstrip/stacked patch antenna elements is 4, thereby forming a 4×4 array of the plurality of microstrip/stacked patch antenna elements in the Panel 1. FIG. 1 illustrates the four panels (Panel 1, Panel 2, Panel 3, and Panel 4) which are numbered sequentially in anticlockwise direction. The plurality of antenna elements is arranged on each of the panels. FIG. 1 comprises lower-band microstrip antenna array elements corresponding to 28 GHz depicted as first lower-band microstrip antenna array elements 110, second lower-band microstrip antenna array elements 112, third lower-band microstrip antenna array elements 114, and fourth lower-band microstrip antenna array elements 116 corresponding to panel 1, panel 2, panel 3, and panel 4 respectively. FIG. 1 depicts port numbers P1, P2, . . . , P16 which correspond to the lower-band microstrip antenna array elements and the port numbers (P17, P18, . . . , P32) which correspond to the upper-band microstrip antenna elements. The upper-band microstrip antenna elements corresponding to 38 GHz, are shown in FIG. 1 as first upper-band microstrip antenna array elements 118, second upper-band microstrip antenna array elements 120, third upper-band microstrip antenna array elements 122, and fourth upper-band microstrip antenna array elements 124 corresponding to panel 1, panel 2, panel 3, and panel 4 respectively. In an example embodiment, the total size of each of the four MIMO antenna array is 48.18×48.18×0.73 mm³.

FIG. 2 depicts the detailed geometry of antenna arrays in the antenna system, according to the embodiments herein. For the case of explanation, FIG. 2 depicts Panel 1 of the antenna system. FIG. 2 illustrates the first upper-band microstrip antenna array elements 118 and the first lower-band microstrip antenna array elements 110. The Panel 1 comprises a plurality of microstrip patch antennas (elements), stacked patch antennas (elements), impedance transformers, meandered series feedlines, and a ground plane. In an example embodiment, the antenna arrays (102, 104, 106, and 108) are composed of two dielectric Taconic TLY-5 substrates (&, =2.2, tan δ=0.0009) of h₁=h₂=0.25 mm, a Taconic FR-28 bonding film (εᵣ=2.72, tan δ=0.0014) of h_{b}=0.11 mm, and three metal layers. In an example, the ground plane and microstrip patch antennas for the lower operating band are printed on the first and second layers of substrate 1 from bottom to top, and stacked patch antennas for the higher operating band are printed on the top side of substrate 2.

According to the embodiments herein, the antenna array utilizes square patch antennas and equal spacing between horizontal and vertical antenna elements to facilitate easy implementation of a shared-aperture dual-band antenna array. The dimension of the microstrip patch antennas is taken for a resonance frequency of 28 GHz. Embodiments herein implement a 1×4 linear antenna array by connecting four microstrip patch antennas with a high-impedance feedline in series. The 5052 microstrip line is chosen to feed the microstrip patch antenna through a quarter-wave transformer. Such four 1×4 series-fed microstrip patch antenna arrays are replicated uniformly to implement 4×4 spatial multiplexing with a spacing of 0.62λ_{H} from each other where λ_{H} is the operating wavelength at a higher operating frequency. Similarly, a 4×4 spatially multiplexed, stacked patch antenna is designed to achieve resonance at 38 GHZ, according to the embodiments herein. This is strategically oriented orthogonal above lower-frequency microstrip antenna elements, utilizing a shared-aperture design for efficient space use. This arrangement helps achieve good isolation between antenna array elements for lower and higher bands since one element's non-emitting edge overlaps with another's radiating edge. According to the embodiments herein, the 8-port MIMO antenna array features dual-band dual-beam operation, with vertical polarization at 28 GHz and horizontal polarization at 38 GHz.

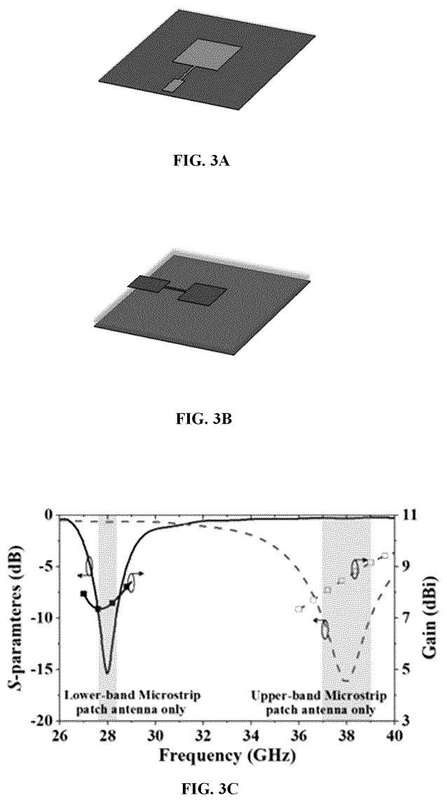

FIGS. 3A and 3B illustrate the configuration of the individual microstrip patch antennas as described in FIGS. 1 and 2, according to the embodiments herein. FIG. 3A depicts the configuration of the microstrip patch antenna operating at a lower operating frequency (28 GHz), according to the embodiments herein. In an example, the lower frequency microstrip patch antenna comprises a quarter-wave impedance transformer-fed microstrip patch antenna printed on a 0.25 mm thick dielectric Taconic TLY-5 substrate above a ground plane. FIG. 3B illustrates the configuration of the patch antenna operating at a higher operating frequency (38 GHz), according to the embodiments herein. The plurality of microstrip patch antenna elements are excited by microstrip feedlines with fixed width and an impedance transformer. A spacing between the plurality of stacked patch antenna elements and the plurality of microstrip patch antenna elements comprises a bonding layer/film and a dielectric substrate. In an example, the higher frequency patch antenna comprises a quarter-wave impedance transformer-fed microstrip patch antenna printed on two 0.25 mm dielectric Taconic TLY-5 substrates and 0.1 mm thick a Taconic FR-28 bonding film with ground plane at the bottom. FIG. 3C illustrates the reflection coefficients and gain plot for the lower frequency and the higher frequency microstrip patch antennas. It can be observed, from FIG. 3C that the lower frequency microstrip patch antenna resonates at 28 GHz with operating bandwidth (for reflection coefficients less than −10 dB) ranging from 27.62 to 28.35 GHZ (2.61%) with a peak realized gain of 7.35 to 7.64 dBi. The higher frequency microstrip patch antenna resonates at 38 GHz with an operating bandwidth ranging from 37.08 to 38.94 GHZ (4.89%) with a peak realized gain of 7.94 to 9.15 dBi.

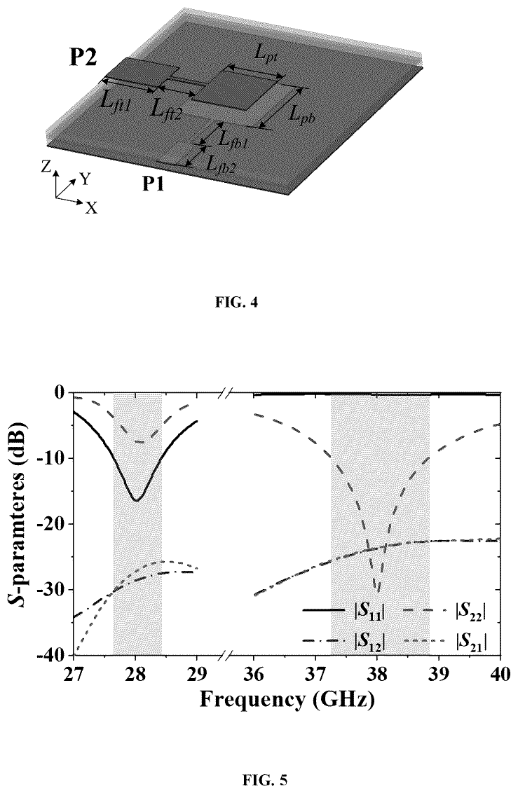

FIG. 4 illustrates how the shared aperture is configured in a microstrip patch antenna element, according to the embodiments herein. The shared aperture comprises a microstrip patch antenna printed on the second layer, and a stacked patch antenna printed on the third layer. In an example, both patch antennas are fed orthogonally with feedlines, such as, but not limited to, microstrip feedlines, of a width of W_{fl1} and W_{fh1} corresponding to 50Ω through appropriate impedance matching techniques. In yet another example, coaxial feedlines can be used instead of microstrip feedlines to directly feed the patch antennas at a specific point where the input impedance of patch antenna matches that of the feed line (typically 50Ω). In an example, the impedance matching technique is quarter-wave transformer. In an example, the dimensions of the quarter-wave transformer are taken as L_{fl2}=L_{fh2}=0.25λ (where λ is the operating wavelength is) with W_{fl2} and W_{fh2} optimized around 115Ω.

FIG. 5 depicts a plot showing the simulated reflection and coupling coefficients of the microstrip patch antenna, according to the embodiments herein. The microstrip patch antenna maintains the operational bandwidth ranging from 27.64 to 28.42 GHZ (2.78%) when port 1 is active and from 37.13 to 38.92 GHz (4.7%) when port 2 is activated, matching the performance of individual microstrip patch antennas. It achieves a minimum port-to-port isolation of 22.9 dBi over both the operating bands.

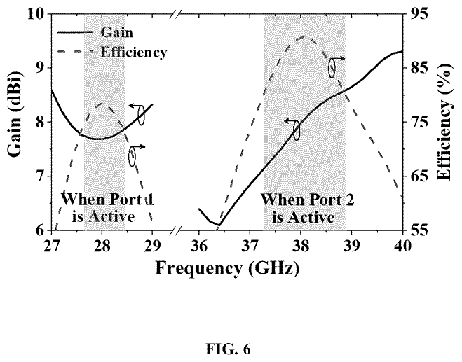

FIG. 6 depicts the simulated gain and efficiency of the single shared-aperture dual-band dual-beam stacked microstrip patch antenna element, according to the embodiments herein. FIG. 6 shows that, for lower-bands, the peak realized gain is flat around 7.65±0.1 dBi with total efficiency varying between 73.2 to 78.5%, whereas for higher-bands, the realized gain is increasing from 7.08 to 8.53 dBi with total efficiency varying between 78.3 to 90.8%.

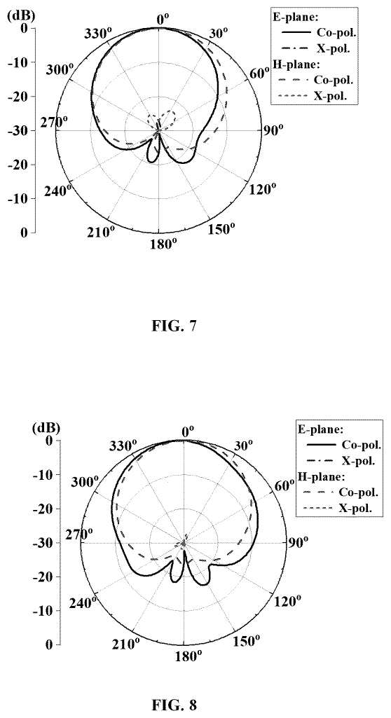

FIG. 7 and FIG. 8 depicts the simulated normalized radiation patterns of the single shared-aperture dual-band dual-beam stacked microstrip patch antenna element when port 1 is active at 28 GHz and port 2 is active at 38 GHZ, according to the embodiments herein. The radiation patterns are plotted in two principal E- and H-planes. It can be seen that the radiation patterns are stable and remain at the broadside direction for both operating bands. The cross-polarization levels are lower than −28 dB in the broadside direction.

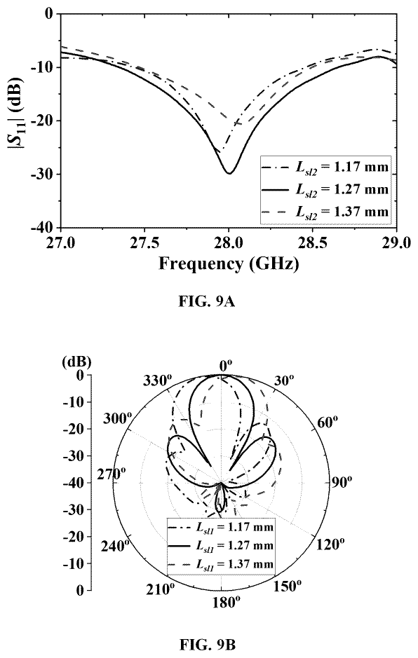

To achieve a broadside radiation pattern, all radiating elements must be excited in phase. A microstrip patch antenna inherently introduces a 180° phase shift along its two radiating edges; therefore, an additional 180° phase shift is introduced by utilizing a feedline of length λ/2. In order to accommodate the feedline within a small inter-element spacing, the length of the feedline is meandered. The meandered series feedline is arranged in between each of the plurality of microstrip patch antenna elements. FIG. 9 depicts the effect of variation in Lₛₗ₂ of the 1×4 series-fed microstrip patch antenna array (Port 1) of 4×4 dual-band dual-beam series-fed stacked microstrip patch MIMO antenna array in lower-band, according to the embodiments herein. As the length Lₛₗ₂ of the 1×4 series-fed microstrip patch antenna array (Port 1) (lower-band second meandering series feedline section length) is increased from 1.17 to 1.37 mm, the 1×4 series-fed microstrip patch antenna array (Port 1) controls the impedance matching and increases its resonance frequency from 27.92 to 28.08 GHz. Also, when the length of the feedline is not equal to λ/2, the microstrip patch antenna elements are fed with progressive shifts, producing squinted beams. It can be seen from the E-plane (yoz-plane) radiation pattern at 28 GHz the beam is squinted from −9° to +10° for increased Lₛₗ₂. At Lₛₗ₂=1.27 mm, the 1×4 series-fed microstrip patch antenna array achieves resonance at 28 GHz with reflection coefficient of −29.85 dB with beam directed at 0°.

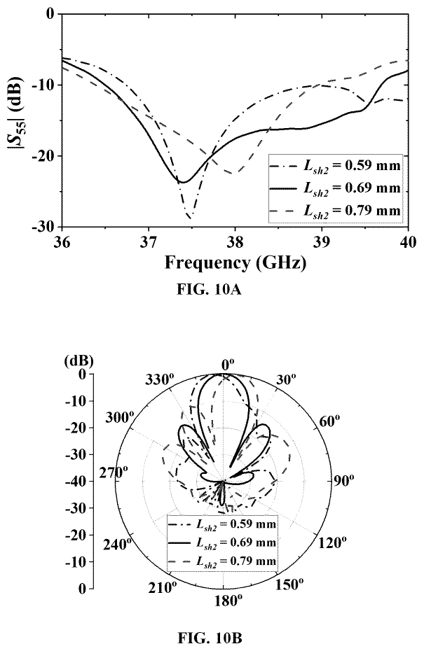

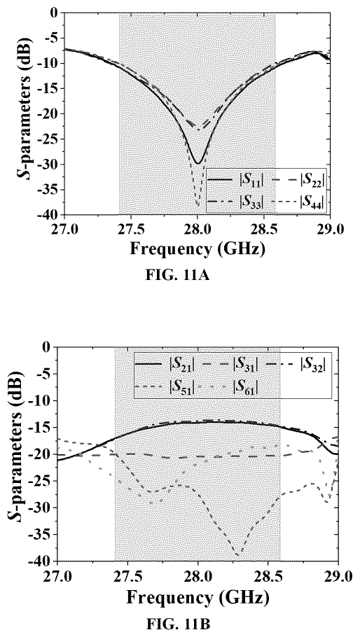

FIG. 10 depicts the effect of variation in Lₛₕ₂ of the 1×4 series-fed stacked patch antenna array (Port 5) of 4×4 dual-band dual-beam series-fed stacked microstrip patch MIMO antenna array in higher-band, according to the embodiments herein. As the length of the higher-band second meandering series feedline section (Lₛₕ₂) is varied, it controls the impedance matching over the entire bandwidth, achieving a wide impedance bandwidth from 36.5 to 39.67 GHz at Lₛₕ₂=0.69 mm. Also, the 1×4 series-fed stacked patch antenna array obtains a beam directed at 0° at 38 GHZ.

FIG. 11 depicts the simulated S-parameters of an 8-port 4×4 series-fed stacked microstrip patch MIMO antenna array in lower-band, according to the embodiments herein. For brevity, the reflection coefficients are only plotted for ports operating in the lower-band, while the coupling coefficients are only plotted when port 1 is active and ports adjacent to it are not excited. All not-excited ports are terminated with 50Ω matched loads. The 1×4 microstrip patch antenna arrays (Port 1 to Port 4) cover a minimum bandwidth from 27.38 to 28.6 GHZ (4.3%) for reflection coefficients less than −10 dB. The port-to-port isolation is more than −13.8 dB within the entire operating band, with the maximum value reaching up to −39.2 dB, indicating good isolation at the lower-band.

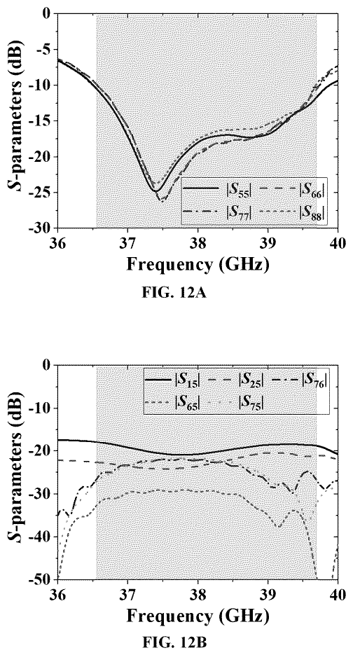

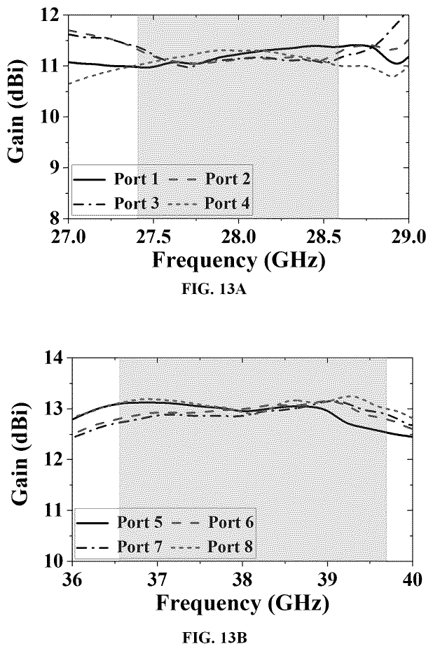

FIG. 12 depicts the simulated S-parameters of an 8-port 4×4 series-fed stacked microstrip patch MIMO antenna array in higher-band, according to the embodiments herein. The reflection coefficients are plotted only for the ports operating in the higher band, while the coupling coefficients are plotted only when port 5 is active, with the adjacent ports included for brevity. The 1×4 stacked patch antenna arrays (Port 5 to Port 8) cover a bandwidth ranging from 36.57 to 39.68 GHZ (8.16%) with reflection coefficients less than −10 dB. The port-to-port isolation is more than −17.9 dB, with a maximum value of −49.6 dB, indicating good isolation at higher-band as well.

FIG. 13 depicts the simulated peak realized gain of an 8-port 4×4 series-fed stacked microstrip patch MIMO antenna array for lower and higher bands, according to the embodiments herein. The realized peak gain is higher than 11.03 dBi and 12.76 dBi in lower (for Port 1 to 4) and higher (for Port 5 to 8) operating bands, respectively.

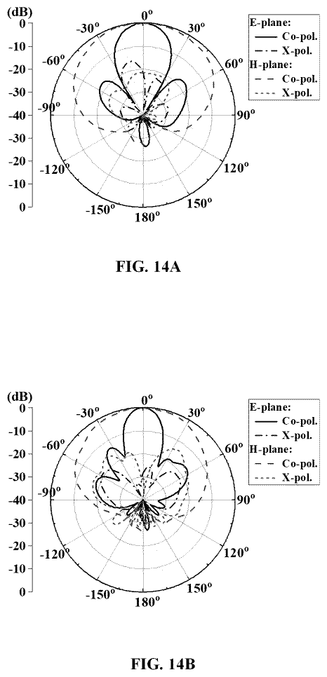

The 8-port 4×4 series-fed stacked microstrip patch MIMO antenna array can operate in either 4-port lower-band and 4-port higher-band spatial multiplexing MIMO antennas and/or (two-, three- or four-port combined) beam steering depending on application requirements. FIGS. 14A and 14B depict the simulated normalized radiation patterns of an 8-port 4×4 series-fed stacked microstrip patch MIMO antenna array when individual ports are excited, according to the embodiments herein. FIG. 14A shows the radiation pattern in two principal planes (E-plane and H-plane) when port 1 is excited at 28 GHZ, according to the embodiments herein. Similarly, the radiation patterns in two principal planes when port 5 is excited at 38 GHz are shown in FIG. 14B. They are stable and remain at the broadside direction for both operating bands with cross-polarization levels and side lobe levels less than 20 dB and 13 dB, respectively. The radiation patterns for Port 2 to Port 4 and Port 6 to Port 8 are not shown for the sake of conciseness.

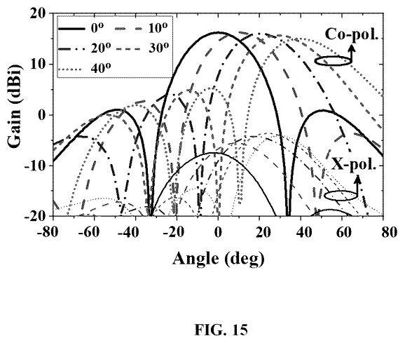

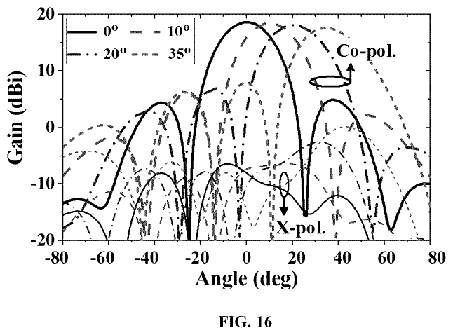

FIGS. 15 and 16 depict the simulated scanning performance of a shared-aperture 8-port 4×4 dual-band dual-beam series-fed microstrip patch antenna array for port 1 to port 4 at 28 GHz and for port 2 at 38 GHz, according to the embodiments herein. In order to achieve good beam scanning characteristics in both operating bands, the spacing between the antenna elements is set at 0.6λ_{H} (where λ_{H} is the higher-band operating frequency). It achieves a maximum 3 dB scanning angle of ±40° at 28 GHz in the H-plane and ±35° at 38 GHz in the E-plane. The side-lobe levels are less than 13 dB and cross-polarization level discrimination is below −10 dB at 28 GHz. Embodiments herein disclose that the side-lobe levels are less than 9.8 dB, and the cross-polarization level is below at 38 GHz across the entire scanning range. In the lower band, the system achieves a half-power beam width of 26°±2°, while in the higher band, it achieves a half-power beam width of 20°±1°.

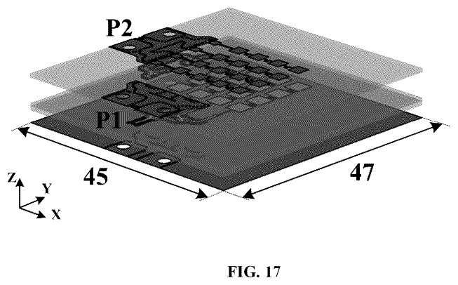

FIG. 17 depicts the perspective view of shared-aperture 4×4 dual-band dual-beam series-fed microstrip patch antenna array fed by the substrate integrated coaxial-line (SICL)-based power-divider network, according to the embodiments herein. For validating the design configuration according to the embodiments herein, a broadside shared-aperture 4×4 dual-band dual-beam series-fed microstrip patch antenna array with a 0° directed radiation pattern designed, fabricated, and tested. Two 1:4 SICL-based power divider networks with equal power and equal phase are designed: one for the lower band at 28 GHZ and another for the higher band at 38 GHz. The total size of the shared-aperture 4×4 dual-band dual-beam series-fed microstrip patch antenna array fed by the SICL-based power-divider network is 45×47×0.73 mm³.

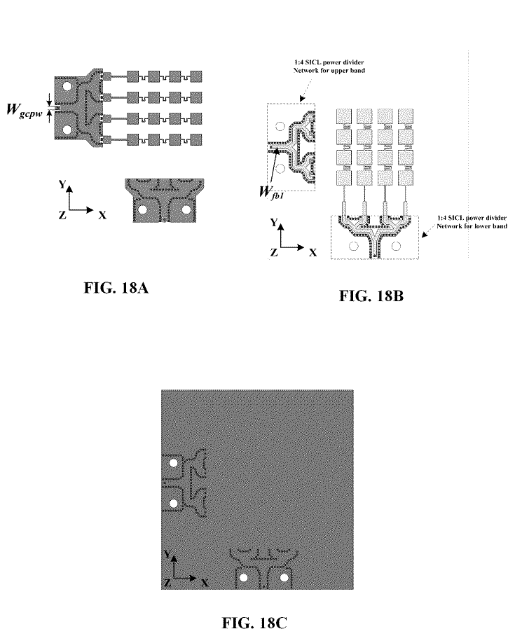

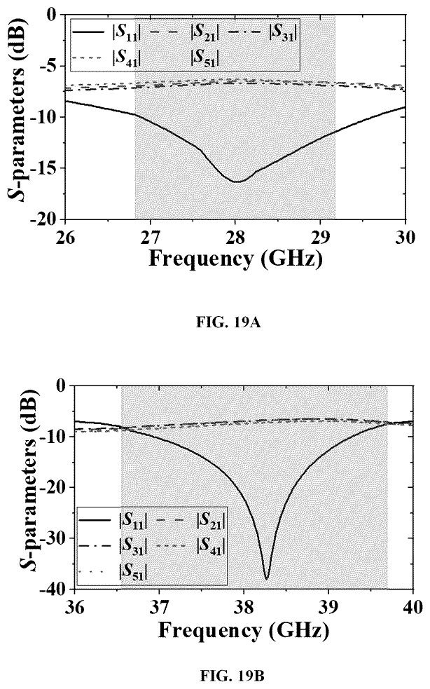

FIGS. 18A, 18B, and 18C depict a layered configuration of shared-aperture 4×4 dual-band dual-beam series-fed stacked microstrip patch antenna array fed by the SICL-based power divider network, according to the embodiments herein. FIG. 18A shows the top layer comprising of series-fed stacked patch antennas printed on top side of the substrate 2 with SICL network top metal layer, grounded coplanar waveguide (GCPW) transition, row of metallic vias on either side of the SICL network inner conductor, and metallic vias connecting inner conductor with GCPW and 50Ω microstrip line feedlines. FIG. 18B shows the middle layer comprising of series-fed microstrip patch antennas printed on the top side of substrate 1 with SICL networks' inner conductor. FIG. 18C shows the bottom layer comprising of a ground plane printed on the bottom side of substrate 1. Holes are created for application of connectors for testing.

FIGS. 19A and 19B depict the simulated S-parameters of the 1:4 SICL-based power dividers network, according to the embodiments herein. To clearly show the performance of the antenna array, the designed 1:4 SICL-based power divider networks are analysed first. The power divider network operates in the lower band at 28 GHZ and in the higher band at 38 GHZ, as shown in FIGS. 19A and 19B, respectively. The reflection coefficients are less than −15 dB, whereas the insertion loss is approximately 1.8 dB.

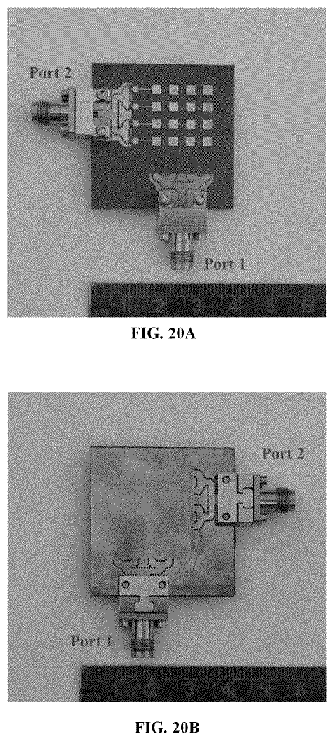

FIG. 20 are photographs depict the fabricated shared-aperture 4×4 dual-band dual-beam series-fed stacked microstrip patch antenna array fed by the SICL power-divider network with top and bottom view, according to the embodiments herein. The Johnson 2.4 mm End Launch connectors are used for giving excitations. The performance is measured using Agilent's PNA-L series Network Analyzer N5234A, and the radiation patterns are measured in an anechoic chamber. Any slight discrepancy between measured and simulated results might be attributed to the fabrication tolerance and/or assembly errors.

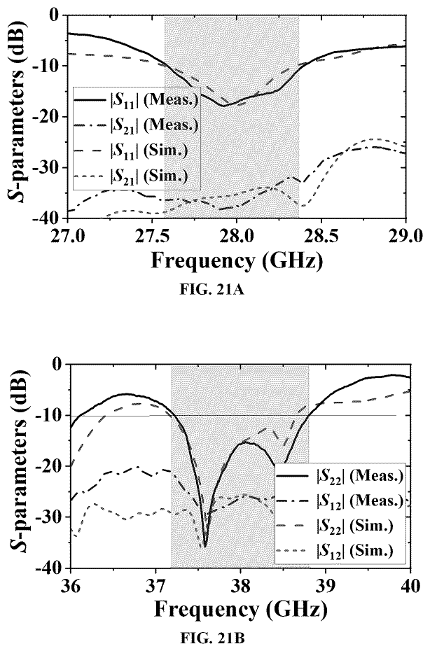

FIG. 21 depicts the simulated and measured S-parameters of shared-aperture 4×4 dual-band dual-beam series-fed stacked microstrip patch antenna array fed by the SICL power-divider network, according to the embodiments herein. In the lower-band, the measured −10 dB impedance bandwidth covers 27.6 to 28.4 GHZ (2.85%) with in-band isolation of 33 dB, which matches the simulated impedance bandwidth of 27.57 to 28.34 GHZ (2.75%) and isolation of 35 dB. In the higher-band, the measured-10 dB impedance bandwidth covers 37.44 to 38.82 GHZ (3.62%) with in-band isolation of 33 dB, which aligns with the simulated impedance bandwidth of 37.24 to 38.49 GHZ (3.3%) and isolation of 28 dB.

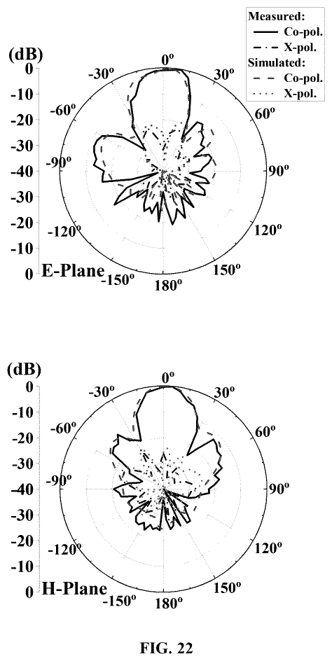

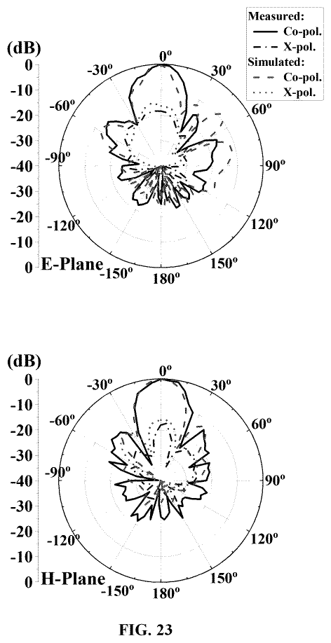

FIGS. 22 and 23 depict the simulated and measured normalized radiation patterns of shared-aperture 4×4 dual-band dual-beam series-fed stacked microstrip patch antenna array fed by the SICL power-divider network in its principal planes (E-plane and H-plane) for port 1 at 28 GHz and for port 2 at 38 GHz, according to the embodiments herein. For the 28 GHz radiation pattern, the E-plane is the yoz-plane, and the H-plane is the xoz-plane. For the 38 GHz radiation pattern, the E-plane is the xoz-plane, and the H-plane is the yoz-plane. Strong correlation is observed between the simulated and measured normalized radiation patterns, demonstrating good broadside performance in both principal planes. Across both operating bands, the measured cross-polarization levels remain below −25 dB in the broadside direction.

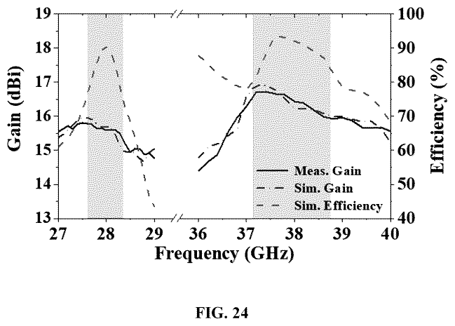

FIG. 24 depicts the simulated and measured peak realized gain and simulated efficiency of shared-aperture 4×4 dual-band dual-beam series-fed stacked microstrip patch antenna array fed by the SICL power-divider network, according to the embodiments herein. The measured gain reaches 15.48-15.78 dBi in lower-band and 15.66-16.52 dBi in higher-band. The simulated radiation efficiency is maintained above 75% and 80% in the lower and higher bands, respectively.

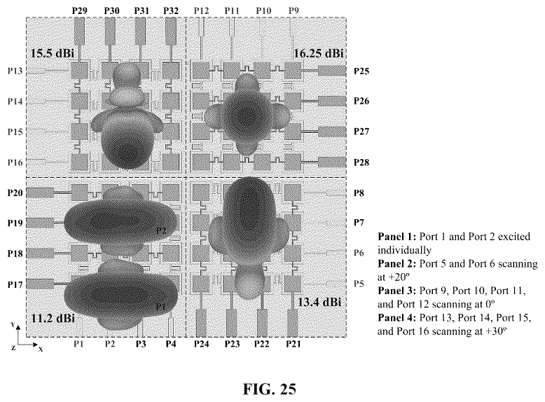

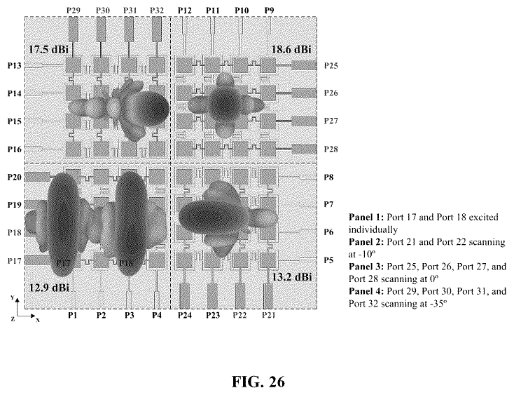

FIGS. 25 and 26 depict the simulated 3D radiation patterns of multi-functional shared-aperture 32-port 16×16 dual-band dual-beam series-fed microstrip patch MIMO antenna array at 28 GHZ and 38 GHz, according to the embodiments herein. FIG. 25 demonstrates multi-functionality of proposed MIMO antenna at 28 GHZ, where Panel 1's port 1 and 2 are excited individually, Panel 2's ports 5 and 6 are scanning at +20°, Panel 3's ports 9, 10, and 11 are scanning at 0°, and Panel 4's ports 13, 14, 15, and 16 are scanning at +30°. FIG. 26 demonstrates multi-functionality at 38 GHz, where Panel 1's port 17 and port 18 are excited individually, Panel 2's ports 21 and 22 are scanning at −10°, Panel 3's ports 25, 26, and 27 are scanning at 0°, and Panel 4's ports 29, 30, 31, and 32 are scanning at −35°. The 32-port 16×16 MIMO antenna array has a multi-functional capability, supporting 4-panel polarization diversity and allowing each panel to be used for either spatial multiplexing or beamforming. The 32-port 16×16 MIMO antenna array maximizes the data rate and capacity by using multiple beams and improves signal quality and range through beam-steering.

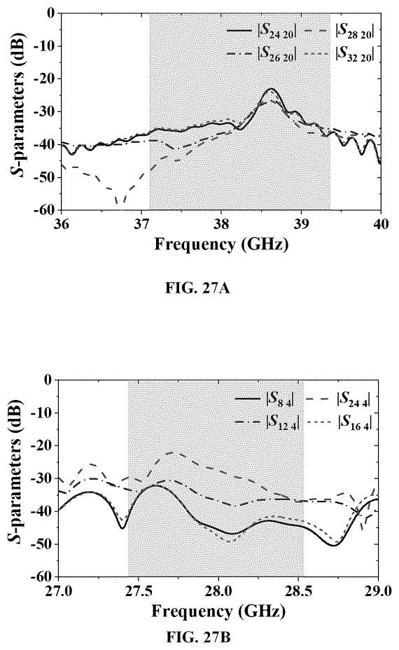

In order to ensure optimal MIMO performance, particularly in systems with closely spaced antenna panels, it is essential to account for the effects of mutual coupling, as this can substantially degrade performance across the operating bands. Key MIMO performance metrics include the coupling coefficient and diversity performance parameters such as the envelope correlation coefficient (ECC) and diversity gain (DG). Achieving minimal mutual coupling between the antenna array elements is critical for maintaining high isolation and enhancing overall performance. FIGS. 11 and 12 show that a minimum isolation of 13.8 dB and 17.9 dB is achieved for the lower and higher bands, respectively, between any of the 1×4 series-fed microstrip patch antenna arrays within a single panel. FIG. 27 illustrates the simulated MIMO performance metrics, in terms of coupling coefficients for the multi-functional shared-aperture 32-port 16×16 dual-band dual-beam series-fed microstrip patch MIMO antenna array. These metrics depict the coupling coefficients between the 1×4 series-fed microstrip patch antenna array and the adjacent antenna array, as well as the polarization diversity antenna array within all other panels. It is observed that the shared-aperture 8-port 4×4 dual-band dual-beam series-fed microstrip patch MIMO antenna array achieves a minimum isolation of 22 dB in the lower band and 26 dB in the higher band, both of which fall within the acceptable limits.

The Envelope Correlation Coefficient (ECC) quantifies the correlation between the radiated beams from antenna arrays within a single panel and those from other panels in the array. A lower ECC value indicates greater independence of the beams, allowing each antenna array to transmit and receive distinct signals with minimal interference. Diversity Gain (DG) measures the improvement in signal-to-noise ratio provided by the MIMO system compared to a single antenna system, reflecting the system's ability to leverage multiple signals for enhanced performance. ECC and DG values are calculated using the formulas provided in Table 1.

TABLE 1

| | | Values |
|---|---|---|
| Parameter | Description | (mm) |
| Lₚₗ | Length of the lower-band patch | 3.31 |
| L_{fl1} | Length of the lower-band microstrip feedline | 2.858 |
| W_{fl1} | Width of the lower-band microstrip feedline | 0.76 |
| L_{fl2} | Length of the lower-band impedance transformer | 3.478 |
| | feedline | |
| W_{fl2} | Width of the lower-band impedance transformer | 0.19 |
| | feedline | |
| Lₛₗ₁ | Length of the lower-band first meandered series | 0.535 |
| | feedline section | |
| Lₛₗ₂ | Length of the lower-band second meandered series | 1.27 |
| | feedline section | |
| Wₛₗ | Width of the lower-band microstrip feedline | 0.23 |
| | section | |
| Wₛₗ₂ | Width of the lower-band meandered section | 0.68 |
| Lₚₕ | Length of the higher-band patch | 2.48 |
| L_{fh1} | Length of the higher-band microstrip feedline | 3.951 |
| W_{fh1} | Width of the higher-band microstrip feedline | 1.68 |
| L_{fh2} | Length of the higher-band impedance transformer | 2.8 |
| | feedline | |
| W_{fh2} | Width of the higher-band impedance transformer | 0.33 |
| | feedline | |
| Lₛₕ₁ | Length of the higher-band first meandered series | 0.86 |
| | feedline section | |
| Lₛₕ₂ | Length of the higher-band second meandered | 0.69 |
| | series feedline section | |
| Wₛₕ | Width of the higher-band microstrip feedline | 0.16 |
| | section | |
| Wₛₕ₂ | Width of the higher-band impedance transformer | 0.72 |
| | feedline | |
| Lₛ | Length of the antenna unit Panel substrate | 27 |
| Sₚ | Spacing between microstrip patch antenna | 4.6 |
| | elements | |
| h₁ | Height of substrate 1 | 0.25 |
| h_{b} | Height of bonding film | 0.11 |
| h₂ | Height of substrate 2 | 0.25 |

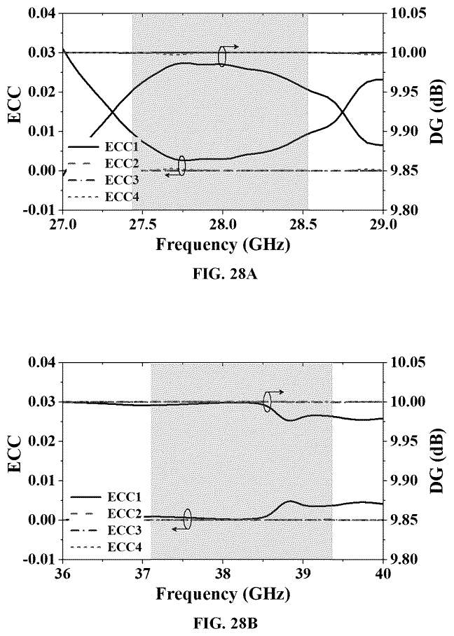

FIGS. 28A and 28B depict the simulated MIMO performance metrics for ECC and DG of the multi-functional shared-aperture 32-port 16×16 dual-band dual-beam series-fed microstrip patch MIMO antenna array across different scenarios, according to the embodiments herein. FIG. 28A presents ECC and DG values in the lower band for four cases: Case 1 involves exciting Port 1 and Port 2 of Panel 1, Case 2 involves exciting Port 1 of Panel 1 while scanning at +20° with Ports 5 and 6 of Panel 2, Case 3 involves exciting Port 1 of Panel 1 while scanning at 0° with Ports 9, 10, and 11 of Panel 3, and Case 4 involves exciting Port 1 of Panel 1 while scanning at +30° with Ports 13, 14, 15, and 16 of Panel 4. FIG. 28B shows ECC and DG values in the higher band for four cases: Case 1 involves exciting Port 17 and Port 18 of Panel 1, Case 2 involves exciting Port 1 of Panel 1 while scanning at −10° with Ports 21 and 22 of Panel 2, Case 3 involves exciting Port 1 of Panel 1 while scanning at 0° with Ports 25, 26, and 27 of Panel 3, and Case 4 involves exciting Port 1 of Panel 1 while scanning at −35° with Ports 29, 30, 31, and 32 of Panel 4. Across all cases, the ECC values remain at 0.1, well below the practical acceptable limit of 0.5, while the DG values are just under the acceptable limit of 10 dB, at approximately 9.95 dB.

Embodiments herein disclose a multi-functional shared aperture 8N-port MIMO antenna system, which is multifunctional and which can be utilized for dual-band 4N×4N spatial multiplexing, dual-band 2N×2N dual-polarized spatial multiplexing, or dual-band N×N polarization diversity MIMO configurations. Each configuration supports dual-band N×N spatial multiplexing MIMO antennas and/or beam steering capabilities at 28 GHz and 38 GHZ frequency bands. By positioning the microstrip patch antenna elements at 0.6λ_{H} at higher operating frequencies, a minimum scanning angle of ±35° is achievable in both operating bands. The antenna features a lightweight and simple feed network, enabling easy integration with planar circuitry. Additionally, the shared-aperture characteristics eliminate the need for separate antennas, reducing both cost and space requirements. The disclosed MIMO antenna is novel, less complex, easy to fabricate, and demonstrates diversity performance well above accepted limits. It maximizes data rate, capacity, signal quality, and range by utilizing polarization diversity, allowing each panel element to be used for spatial multiplexing or beamforming. Furthermore, the antenna is well-suited for 5G and beyond 5G millimeter-wave communication applications in both base stations and user equipment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed is:

1. A multifunctional shared aperture 8N-port MIMO antenna system comprising:
a plurality of panels comprising at least one MIMO antenna array,
wherein the at least one MIMO antenna array in each of the plurality of panels comprises a plurality of microstrip patch antenna elements and a plurality of stacked patch antenna elements;
wherein the plurality of microstrip patch antenna elements for obtaining a lower operating frequency are spaced apart from each other in a linear array configuration;
wherein the plurality of stacked patch antenna elements for obtaining a higher operating frequency are placed on top of the plurality of microstrip patch antenna elements;
wherein a feedline connects each of the plurality of stacked patch antenna elements in series such that the feedline introduces a 180° phase shift between the plurality of microstrip/stacked patch antenna elements, and wherein the plurality of stacked patch antenna elements are oriented at a predefined angle of 90° relative to the plurality of microstrip antenna elements; and
wherein a panel from the plurality of panels is arranged at a pre-defined angle of 90° relative to an adjacent panel from the plurality of panels for polarization diversity to obtain the multifunctional shared aperture 8N-port MIMO antenna system.

2. The antenna system as claimed in claim 1, wherein the linear array configuration of the plurality of microstrip patch antenna elements and the plurality of stacked patch antenna elements comprises 1×N linear arrays with a total of 2N ports, thereby forming an N×N array of the plurality of microstrip/stacked patch antenna elements in each of the panel, wherein N denotes number of microstrip/stacked patch antenna elements in a row of the linear array.

3. The antenna system as claimed in claim 1, wherein each of the plurality of microstrip patch antenna elements and each of the plurality of stacked patch antenna elements are fed orthogonally using feedlines, wherein the feedlines are configured to match an input impedance of the each of the plurality of microstrip and stacked patch antenna elements through impedance matching techniques.

4. The antenna system as claimed in claim 1, wherein the series feedline is arranged in between each of the plurality of microstrip patch antenna elements, and wherein the series feedline is a feedline technique that introduces a 180° phase shift along two radiating edges of each of the plurality of microstrip patch antenna elements.

5. The antenna system as claimed in claim 1, wherein a spacing between the plurality of stacked patch antenna elements and the plurality of microstrip patch antenna elements comprises a bonding layer and a dielectric substrate.

6. The antenna system as claimed in claim 1, wherein the at least one MIMO array is arranged orthogonal to at least one other MIMO array for polarization diversity.

7. The antenna system as claimed in claim 1, wherein the plurality of microstrip/stacked patch antenna elements are placed uniformly in the at least one array with a spacing of 0.6λ_{H} from each other in order to achieve wide scanning range in the higher and lower operating frequencies, where λ_{H} is the operating wavelength at the higher operating frequency.

8. The antenna system as claimed in claim 1, wherein the antenna system is utilized for one or more of dual-band 4N×4N spatial multiplexing, dual-band 2N×2N dual-polarized spatial multiplexing, and dual-band n×n polarization diversity MIMO configurations, wherein each configuration supports one or more of dual-band N×N spatial multiplexing MIMO antennas and beam steering capabilities at lower and higher operating frequencies.

9. The antenna system as claimed in claim 1, wherein the antenna system achieves an isolation of any two ports and diversity performance between in terms of Envelope Correlation Coefficient (ECC) and Diversity Gain (DG) between any two radiated beams markedly below a practical limit for both the lower and higher operating frequencies.
